(19) United States
(12) Patent Application Publication
(10) Pub. No.: US 2003/0033343 A1
(43) Pub. Date: Feb. 13, 2003

(54) Carry-ripple adder

(76) Inventors: Joel Hatsch, Unterhaching (DE); Winfried Kamp, Munchen (DE); Siegmar Koppe, Laatzen (DE); Ronald Kunemund, Dietramszell (DE); Eva Lackerschmid, Munchen (DE); Heinz Soldner, Bruckmuhl-Heufeldmuhle (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/215,454

(22) Filed: Aug. 9, 2002

(30) Foreign Application Priority Data
Aug. 9, 2001 (DE) 101 39 099.8

(51) Int. Cl. G06F 7/50

(52) U.S. Cl. 708/700

(57) ABSTRACT

A carry-ripple adder contains 4 or 3 first inputs for receiving 4 or 3 input bits which have the same significance w and are to be summed, and 2 second inputs for receiving two carry bits with the significance w. In addition, the adder contains an output for a sum bit with the significance w and two outputs for two carry bits with the significances 2w and 4w.

### BACKGROUND OF THE INVENTION

Field of the Invention

The invention relates to carry-ripple adders and carry-accelerated adders for summing a multiplicity of bit sets. The bits contained in one bit set have the same significance, and bits from different bit sets have different-significances.

Carry-ripple (CR) adders are also known in the field as adders with parallel carry logic. Comparable to a carry-save (CS) adder, they have a plurality of inputs with the same significance and sum the bits present at the inputs during operation. The sum of the bits is output to outputs with different significances, for example in a dual-coded numerical representation.

An essential characteristic of CR adders is that they have inputs with different time characteristics. In contrast to the inputs of CS adders, the inputs of CR adders can therefore not be interchanged at will with equal priority. This is explained below for the example of the known 3-to-2 CR adder with 3 inputs and 2 outputs (referred to below as “2and1-to-2 CR adder” in order to differentiate the inputs which do not have equal priority).

The known 2and1-to-2 CR adder contains two first inputs for receiving one input bit each, and a third input at which there is a carry bit which is output by a 2and1-to-2 CR adder which adds bits of the next lowest significance. The 2and1-to-2 CR adder has two outputs, one of the outputs outputting the sum bit with the significance of the input bits of this adder while the other output is a carry output which has twice the significance and at which the carry bit for the 2and1-to-2 CR adder for summing bits of the next highest significance is output.

Thus, with CR adders it is always necessary when calculating the sum bit to take into account a carry bit which must still however, have been previously calculated in the CR adder with the next lowest significance. In order to avoid a situation in which a time-consuming calculation procedure comes about in such a case, it is necessary with CR adders to ensure, by a suitable internal circuit set-up or gate set-up, that the carry bit can be calculated from the input bits with as few gates as possible in the critical path between the carry input (“carry in”), and the carry output (“carry out”). In this way, the entire carry path is optimized as it is composed of as few gates as possible.

The 2and1-to-2 CR adder can add merely two bits. In order to add three or more dual numbers, it is necessary, however, to add a correspondingly higher number of bits per place. Usually, a Wallace Tree (WT) adder is used for adding more than two bits with the same significance. A WT adder is a multi-stage adder that reduces the number of bits to be added in each stage. The individual stages of a WT adder are made up of 3-to-2 CS full adders that are disposed in parallel with one another. The number of required 3-to-2 CS full adders is reduced with each stage. As soon as the number of bits to be summed is reduced to the value 2, the already mentioned 2and1to-2 CR adder is used as the last, terminating stage.

### SUMMARY OF THE INVENTION

It is accordingly an object of the invention to provide a carry-ripple adder that overcomes the above-mentioned disadvantages of the prior art devices of this general type, which can advantageously be used in a multiplicity of adder configurations. In particular, the intention is to permit a high adding speed and to reduce the number of stages of known adder structures.

With the foregoing and other objects in view there is provided, in accordance with the invention, a 4and2-to-3 bit carry-ripple adder. The 4and2-to-3 bit carry-ripple adder has four first inputs for receiving four input bits to be summed and each having a significance w, two second inputs for receiving two previous carry bits each having the significance w, and a first output for a sum bit with the significance w. The first output is coupled to the second inputs. Two second outputs for two carry bits having significances 2w and 4w, respectively, are provided. The second outputs are coupled to the first inputs and to the second inputs. Alternatively, a 3and2-to-3 bit carry-ripple adder can be defined which has only three first inputs instead of four first inputs.

Both the 4and2-to-3 CR adder according to the invention and the 3and2-to-3 CR adder according to the invention are capable of adding a larger number of bits (specifically 4 or 3) in one adder stage than the known 2and1-to-2 CR adder. If more than two bits are to be added, it is thus possible—as explained below in more detail—to implement adders with a reduced degree of expenditure of circuitry. By outputting two carries with different significance, it is possible to represent three output signals for adding a total of six (4and2-to-3 CR adder) or five (3and2-to-3 CR adder) bits at the inputs of the respective CR adder in each case.

Particularly preferred embodiments of the CR adders according to the invention are characterized in that there is a maximum number of 4 gates between any first input and any of the outputs for the carry bits.

In addition it is preferred that, in the CR adders according to the invention, there is a maximum number of 2 gates between any second input (carry input) and any of the outputs for the carry bits. As a result, in each case the critical path of the CR adders according to the invention are optimized, i.e. their computing speed is accelerated.

By simultaneously generating two carries with different significance, the degree of expenditure on circuitry is lower than in the multi-stage solution with conventional cascaded 3-to-2 CS full adders and a 2and1-to-2 CR adder.

In accordance with an added feature of the invention, a maximum number of two gates are connected between any of the second inputs and the first output for the sum bit.

With the foregoing and other objects in view there is provided, in accordance with the invention, a carry-accelerated adder for summing a multiplicity of bit sets. The bit sets each have bits with equivalent significances, and the bits from different one of the bit sets having different significances. The carry-accelerated adder contains an output end and bit set adders. Each of the bit sets is assigned one of the bit set adders. Each of the bit set adders, while taking into account carries acquired while summing the bit sets with a low significance, calculates a bit with a significance of a respective bit set. At least one of the bit set adders contains the above-described 4and2-to-3 bit carry-ripple adder (3and2-to-3 bit carry-ripple adder) which is disposed at the output end.

The CR adders according to the invention can advantageously be used in relatively large adder structures. In numerous applications, for example in multipliers, adders are required which process a multiplicity of bit sets, the bits contained in a bit set having the same significance, and bits from different sets having different significance. A carry-accelerated adder of the type according to the invention is characterized in that at least one of the bit set adders has a CR adder according to the invention which is disposed at an output end.

If all the bit sets contain a maximum of four (three) bits, i.e. in other words a maximum of four (three) dual numbers are to be added by the carry-accelerated adder, one advantageous embodiment of the carry-accelerated adder is characterized in that all the bit set adders are each implemented in one stage in the form of the 4and2-to-3 (or 3and2-to-3) CR adders according to the invention. In this case, the output for the less significant of the two carry bits is fed to a second input of the respective CR adder for the next highest significance, and the output for the more significant of the two carry bits is fed to a second input of the respective CR adder for the next-but-one highest significance.

A preferred carry-accelerated adder which is also suitable for adding more than four (three) dual numbers is characterized in that a multi-stage bit set adder is assigned to at least one bit set, and in that the output-end stage of the bit set adder is a 4and2-to-3 (or 3and2-to-3) CR adder according to the invention. In this case, the input-end CS adder stages must reduce the number of bits to be added merely to a value of four (three), as a result of which, compared to the prior art in which a 2and1-to-2 CR adder is used at the output end, a lower number of CS adder stages is required.

Other features which are considered as characteristic for the invention are set forth in the appended claims.

Although the invention is illustrated and described herein as embodied in a carry-ripple adder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of an adder tree according to the prior art which is built up from 3-to-2 CS adders and which is provided at the output end with a 2and1-to-2 CR adder;

FIG. 2 is a step diagram explaining a step structure of a known adder-tree for adding 49 bits with the same significance;

FIG. 3 is a block circuit diagram of a 4and2-to-3 CR adder according to the invention;

FIG. 4 is a truth table for the 4and2-to-3 CR adder;

FIG. 5 is a truth table for a 3and2-to-3 CR adder;

FIG. 6 is a block circuit diagram of a first circuit section of the 4and2-to-3 CR adder according to the invention;

FIG. 7 is a block circuit diagram of a second circuit section, adjoining the first section illustrated in FIG. 6, of the 4and2-to-3 CR adder according to the invention;

FIG. 8 is a block circuit diagram of a first circuit section of the 3and2-to-3 CR adder according to the invention;

FIG. 9 is a block circuit diagram of a second circuit section, adjoining the first section illustrated in FIG. 8, of the 3and2-to-3 CR adder according to the invention; and

FIG. 10 is a block circuit diagram explaining a carry-accelerated adder for 4 binary numbers, according to the invention.

### DESCRIPTION OF THE PREFERRED EMBODIMENTS

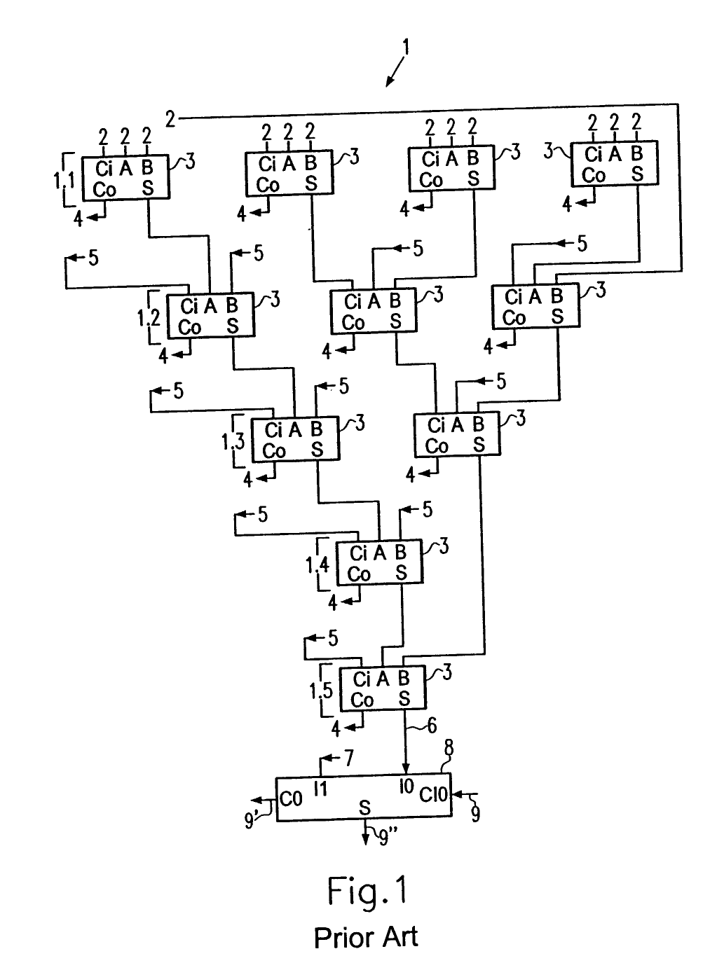

Referring now to the figures of the drawing in detail and first, particularly, to FIG. 1 thereof, there is shown an adder tree composed of a five-stage WT adder 1 with a 2and1-to-2 CR adder 8 which is connected downstream of the WT adder 1 and has the purpose of adding 13 input bits 2 with the same significance according to the prior art.

The WT adder 1 contains a total of 11 3-to-2 CS full adders 3. Each 3-to-2 CS full adder 3 has three inputs A, B, Ci and two outputs S, Co. The inputs A and B are provided for receiving two bits to be added, the input Ci (Carry in) is provided for receiving a carry bit. The three inputs A, B, Ci are equivalent.

The output S represents a sum output of the 3-to-2 CS full adder 3. The output S assumes a value zero if a bit with the value zero is present at all the inputs A, B, Ci, or if a bit with the value 1 is present at precisely two of the inputs A, B, Ci. Otherwise, S=1. An output Co for the carry (carry out) assumes the value 1 only if a bit with the value 1 is present at at least two of the inputs. In contrast to the inputs A, B, Ci, the outputs S and Co are not equivalent.

The five stages 1.1, 1.2, 1.3, 1.4, 1.5 of the WT adder 1 contain 4, 3, 2, 1 or 1 3-to-2 CS full adder 3. The 13 inputs of the WT adder are implemented by 12 inputs 2 of the first stage 1.1, and by an input 2 of the second stage 1.2.

While the outputs S of the first stage 1.1 are each fed to inputs of the CS full adders 3 of the second stage 1.2, the four outputs Co which make available a carry bit 4 are supplied to a second stage of a non-illustrated WT adder for adding a bit set with the next highest significance. Analogously, the 3-to-2 CS full adders 3 of the second stage 1.2 each receive one or two carry bits 5 which are output by a first stage of a non-illustrated WT adder for a bit set with the next lowest significance.

This principle continues over the second stage 1.2 and third stage 1.3, the third stage 1.3 and fourth stage 1.4, and the fourth stage 1.4 and fifth stage 1.5 of the WT adder 1. The output of the WT adder is represented by a sum bit 6 and a partial carry bit 7 that originates from the fifth stage of the WT adder 1 of the next lowest significance. These two bits form the inputs I0, I1 of a 2and1-to-2 CR adder 8 which is connected downstream of the WT adder 1 and which supplies the sum bit 9″ for the bit set in question at its sum output S. For this purpose, the 2and1-to-2 CR adder 8 receives, at an input CI0, a carry bit 9 which is output by a 2and1-to-2 CR adder for the calculation of the sum bit of the next lowest significance, and correspondingly outputs a carry bit 9′ at its carry output C1.

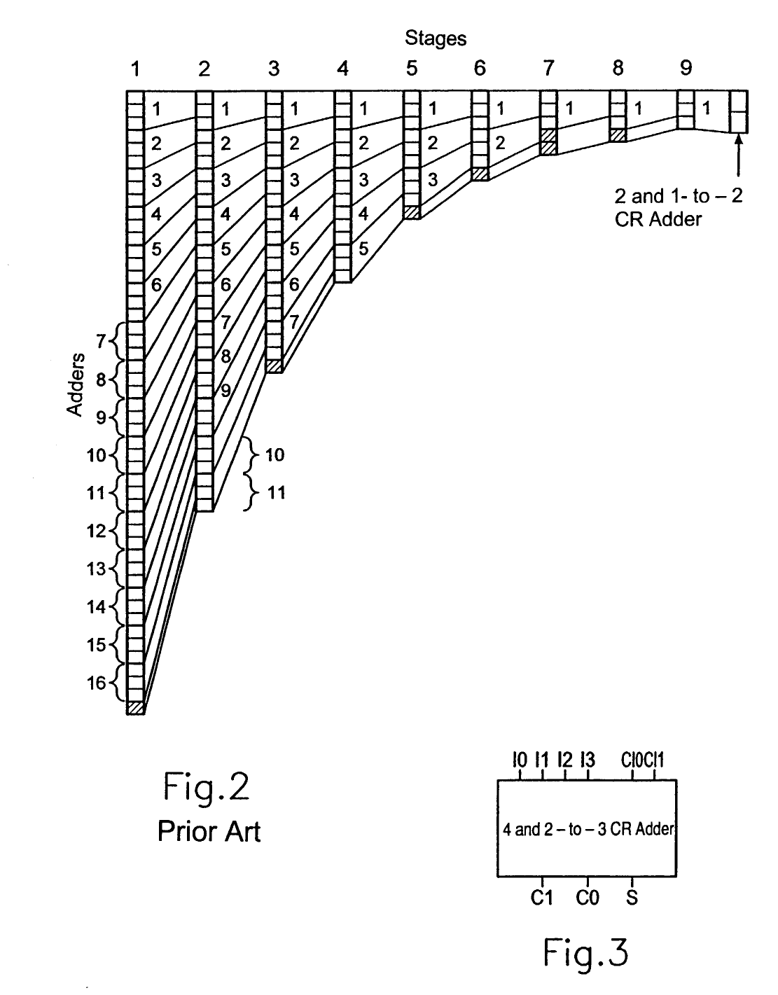

If more than 13 dual numbers are to be added, bit set adders with a correspondingly larger number of inputs are required. FIG. 2 illustrates the step structure of such the WT adder with the 2and1-to-2 CR adder as an output stage for adding 49 bits with the same significance. In the illustration, the input bits of each stage are represented as columns of boxes. Each box corresponds to an input bit. Hatched input bits are not processed in the corresponding stage but rather fed directly to the next stage. As the WT adder receives carry bits from an adjacent non-illustrated WT adder with the next lowest significance in each stage and, as it were, outputs carry bits for a non-illustrated WT adder with the next highest significance—see FIG. 1—FIG. 2 should not be considered to be a circuit diagram but rather solely a representation of the state of the stages.

FIG. 2 indicates that in total nine WT adder stages and one CR output stage are required to add the 49 bits. The first stage has 16 3-to-2 CS full adders and the following stages contain 11, 7, 5, 3, 2, 1, 1 3-to-2 CS full adders. The last stage is a 3-to-2 full adder which is embodied as a 2and1-to-2 bit CR adder, that is to say receives, in a way not illustrated, a carry bit from a 2and1-to-2 CR adder of the adjacent non-illustrated bit set adder with the next lowest significance.

FIG. 3 shows a schematic representation of a 4and2-to-3 CR adder according to the invention. The adder has the inputs I0, I1, I2, I3, CI0, CI1 and the outputs S, C0, C1. The inputs I0 to I3 represent inputs for four input bits with the same significance, while the inputs CI0, CI1 are provided for two carry bits that also have the same significance. All the inputs are equivalent with respect to their logical functionality, i.e. as a result six bits are added.

Differences emerge in the time characteristics of the inputs. The inputs I0 to I3 have identical time characteristics, i.e. can be interchanged with one another. The inputs CI0, CI1 can also be interchanged with one another, but in comparison to the first mentioned “slow” inputs I0 to I3 they have an optimized (shorter) transit time.

The addition of six bits contains a value range between zero and six. The three outputs of the 4and2-to-3 CR adder represent the sum of the bits which are present at the inputs in a dual-coded form. The output S for the sum bit has the same significance as the set of input bits I0 to I3 and CI0, CI1. The output C0 is a carry output that has a significance that is higher than the output S for the sum bit by a factor of 2. The output C1 is also an output for a carry bit but with a significance that is increased once more by the factor 2 in comparison with the output C0. In other words, the outputs S, C0 and C1 have the significances 2⁰, 2¹ and 2² with respect too the significance of the bit set at the input of the 4and2-to-3 CR adder.

With respect to the illustration in FIG. 3, the 3and2-to-3 CR adder according to the invention differs from the 4and2-to-3 CR adder shown in FIG. 3 only in that the input I3 is omitted.

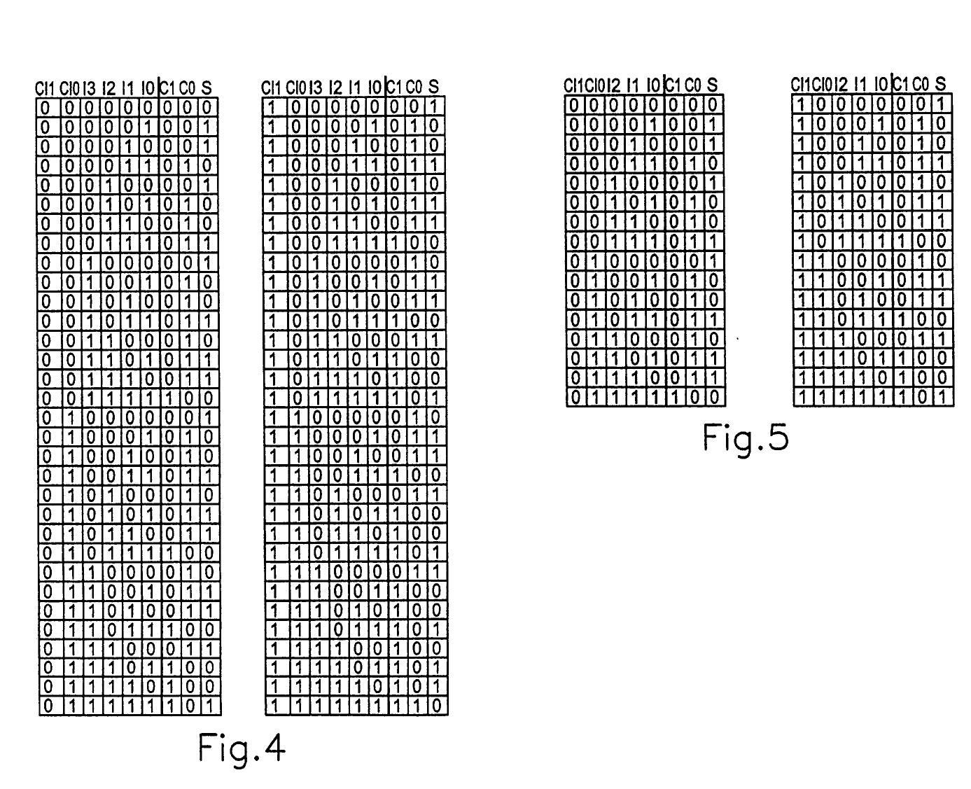

FIG. 4 shows the truth table of the 4and2-to-3 CR adder according to the invention. The truth table of the 3and2-to-3 CR adder according to the invention is shown in FIG. 5.

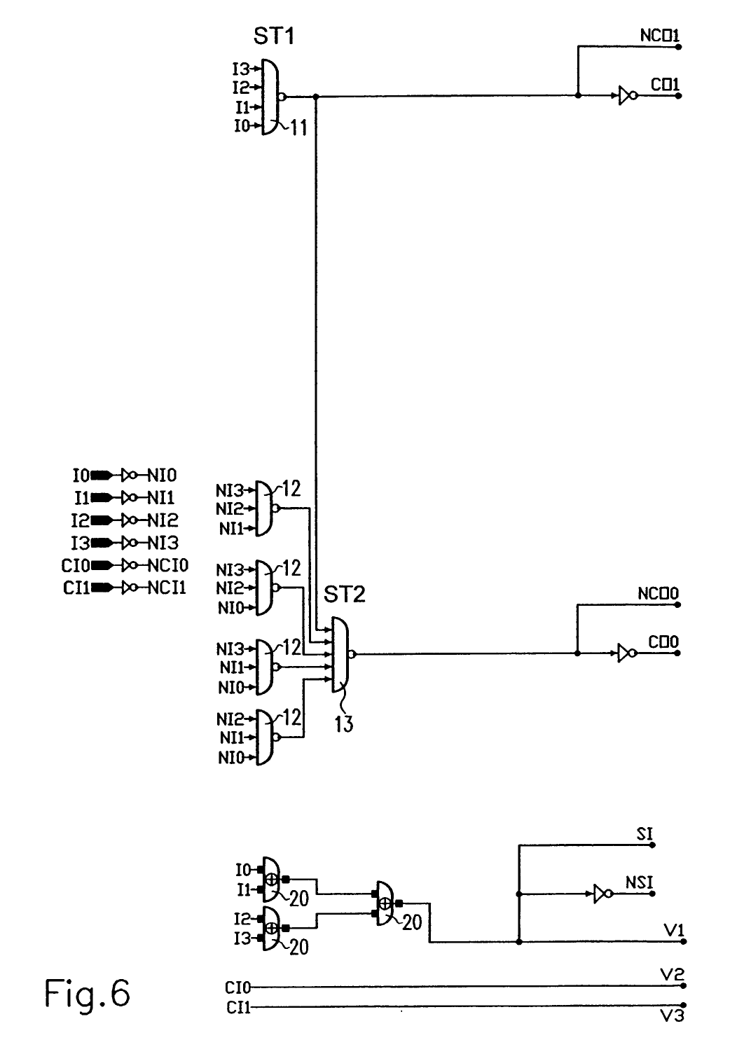

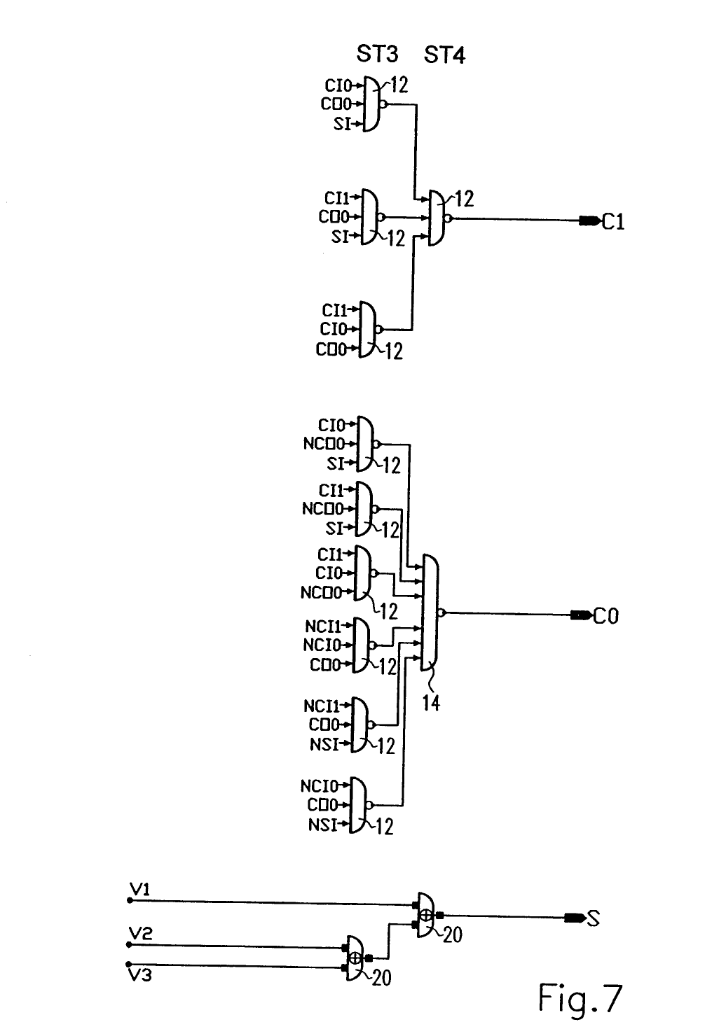

FIGS. 6 and 7 show in combination the gate structure of an exemplary embodiment of a 4and2-to-3 CR adder according to the invention. Here, NI0 to NI3, NCI0, NCI1 designate the inverted inputs I0 to I3, CI0, CI1. This is represented symbolically in the left-hand part of FIG. 6. The wiring of the gates is shown in the further reference symbols illustrated in FIG. 6. V1, V2 and V3 designate here connecting points between the circuit sections shown in FIGS. 6 and 7.

If FIGS. 6 and 7 are viewed in combination it becomes apparent that the carry outputs C0 and C1 are dependent on the assignment of the inputs I0 to I3 and of the carry inputs CI0, CI1. A four-stage gate structure is used to control the carry outputs C0, C1. A first stage ST1 is composed in this respect of a NAND gate 11 with four inputs and four NAND gates 12 with three inputs each. As is apparent from the reference symbols, the NAND gate 11 is non-inverted at all four inputs, and the NAND gates 12 are respectively driven in inverted fashion at all three inputs.

The outputs of the NAND gates 11 and 12 of the first stage ST1 are combined and fed to a NAND gate 13 with five inputs. The NAND gate 13 forms the second stage ST2 of the 4and2-to-3 CR adder with respect to the carry outputs C0, C1.

The third stage ST3 is composed of, with respect to the first carry output C0, six NAND gates 12 with three inputs each. With respect to the second carry output C1, the third stage ST3 has three NAND gates 12 with three inputs each.

The fourth stage ST4 has a NAND gate 14 with six inputs for the low-order carry output C0, and a NAND gate 12 with three inputs for the higher-order carry output C1.

The gate structure for actuating the sum output S also has four stages. The first stage is composed of two XOR gates 20 which are disposed in parallel with one another and which receive the four inputs I0, I1, I2 and I3. The second to fourth stage is composed in each case of a single XOR gate 20.

The circuit diagram shows clearly that the two carry inputs CI0 and CI1 are first fed to the third stage ST3 of the grid structure that is explained. This applies both to the carry outputs C0, C1 and to the sum output S. Accordingly, the bits for the carry inputs CI0, CI1 will be included in the calculation with a shorter time delay than the input bits I0 to I3—they therefore only need to be present at a later time. After the reception of the bits at the carry inputs CI0, CI1, only two gate transit times are required in order to make available the carry bits at the carry outputs C0, C1. (Inverters are represented in the drawing by triangle symbols; they are not taken into account in the counting of the gates and gate transit times for reasons of consistency as they may possibly also be able to be constructed integrated into logic gates).

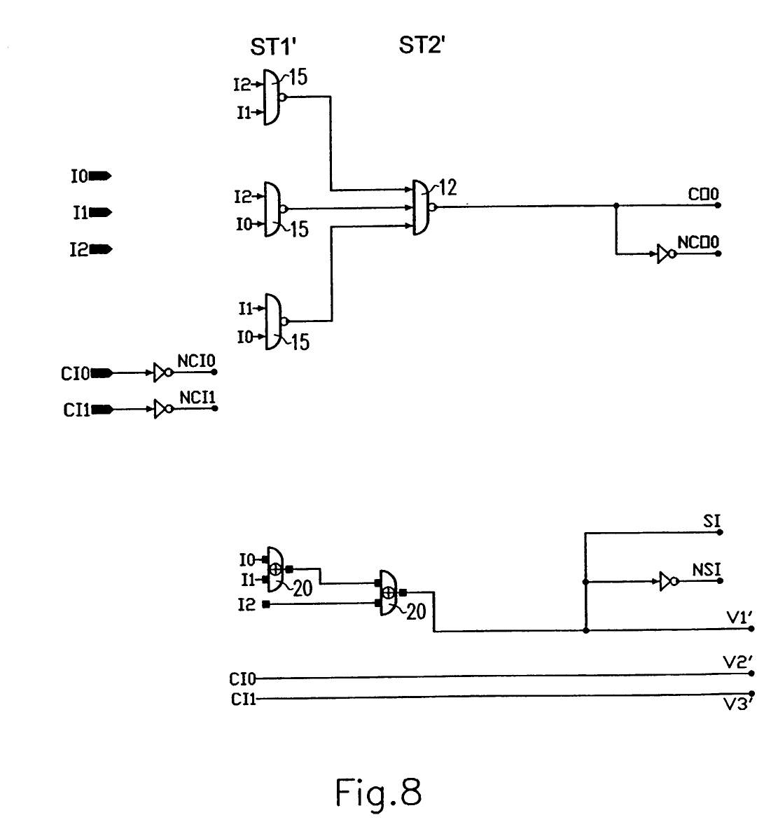

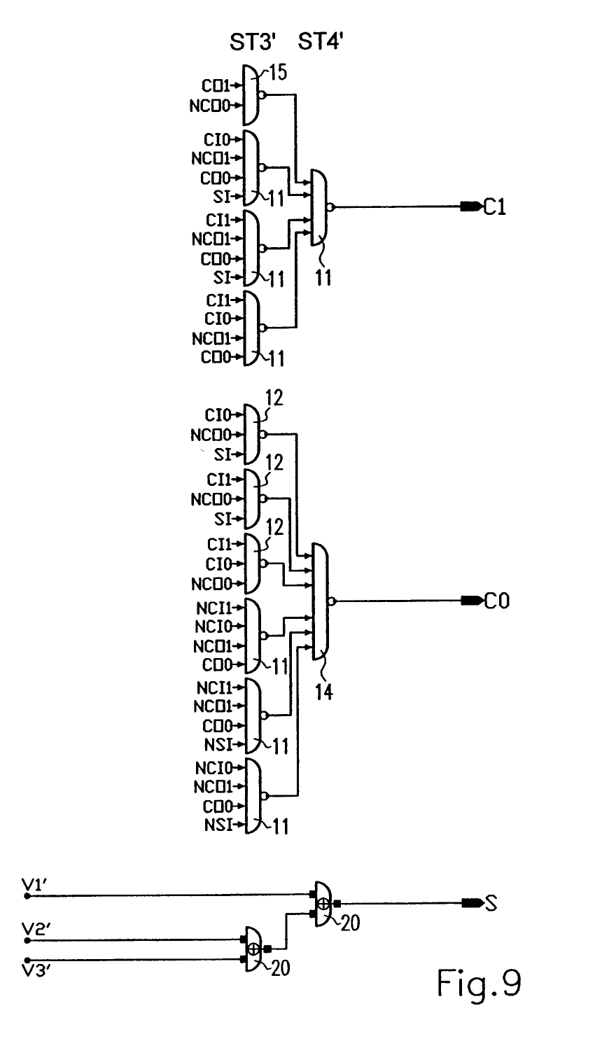

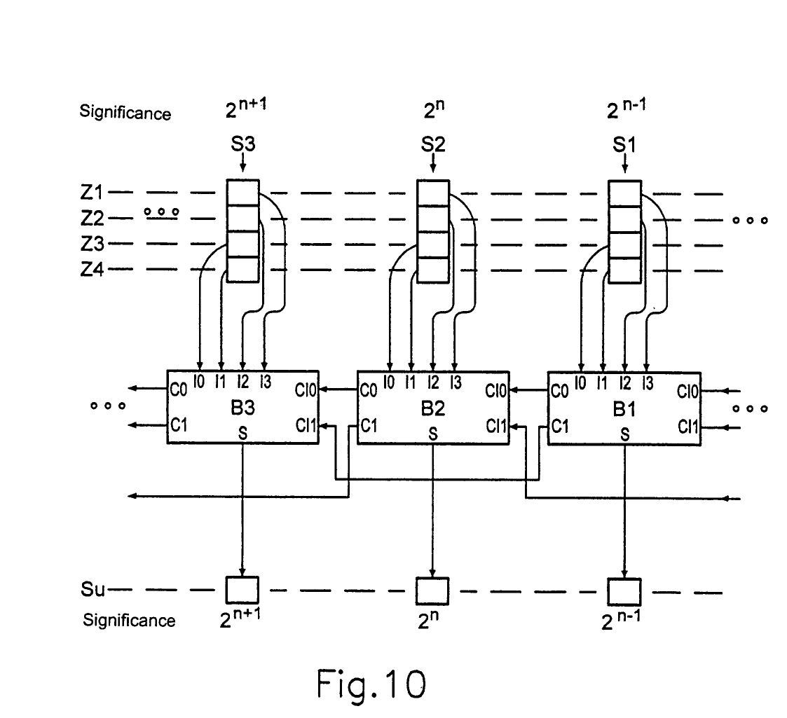

FIGS. 8 and 9 show, viewed in combination, the gate structure of an exemplary embodiment of a 3and2-to-3 CR adder according to the invention. NCI0 and NCI1 in turn designate the inverted carry inputs CI0 and CI1, inverted inputs to the inputs I0 to I2 are not required in the exemplary embodiment illustrated here, see the symbolic representation of the reference symbols used in the left-hand part of FIG. 8.

The wiring of the gates and connection points V1′, V2′ and V3′ between the circuit sections shown in FIGS. 8 and 9 can in turn be inferred from the reference symbols used in the drawing.

The carry bits output at the carry outputs C0 and C1 depend on the assignment of the inputs I0 to I2 and on the carry inputs CI0, CI1. In order to control the carry outputs C0, C1, a four-stage grid structure (inverters are, as mentioned, not counted as gates) is used. A first stage ST1′ is composed, with respect to the carry outputs C0, C1, of three NAND gates 15 with two inputs each. As is apparent from the reference symbols, the three NAND gates 15 are driven in a non-inverted fashion at all the inputs.

The outputs of the three NAND gates 15 of the first stage ST1′ are combined and fed to an NAND gate 12 with three inputs. The NAND gate 12 forms the second stage ST2′ of the 3and2-to-3 CR adder with respect to the carry outputs C0, C1.

The third stage ST3′ is constructed, with respect to the first carry output C0, from three NAND gates 12 with three inputs each and three NAND gates 11 with four inputs each. With respect to the second carry output C1, the third stage ST3′ has three NAND gates 11 with four inputs each, and one NAND gate 15 with two inputs.

The fourth stage ST4′ has, for the low-order carry output C0, a NAND gate 14 with six inputs, and for the higher-order carry output C1 it has a NAND gate 11 with four inputs.

The grid structure for driving the sum output S also has four stages. The first stage is composed of an XOR gate 20, which receives two inputs, for example I0, I1. The second to fourth stage is respectively composed of an individual XOR gate 20, the XOR gate 20 of the second stage receiving the remaining input I2.

Here too, the two carry inputs CI0 and CI1 are first supplied to the third stage ST3′ of the grid structure which is explained. This applies both to the carry outputs C0, C1 and to the sum output S. For this reason, here too, the bits for the carry inputs CI0, CI1 are included in the calculation with a shorter time delay than the input bits I0 to I2, i.e. they only have to be present at the input end at a point in time which is later than the latter by two gate transit times (three gate transit times if the gate transit time of the inverters is included in the calculation).

After the reception of the bits at the carry inputs CI0, CI1, only two gate transit times are required to make available the carry bits at the carry outputs C0, C1.

FIG. 10 shows a section of a circuit diagram of a carry-accelerated adder that can sum a maximum number of four binary-coded numbers Z1, Z2, Z3 and Z4. The bits of the n−1-th place are shown in column S1, the bits of the n-th place are shown in column S2 and the bits of the n+1-th place are shown in column S3, of the binary numbers Z1 to Z4 in each case. Here, n is any desired integral number that is greater than or equal to one. The bits in column S1 thus have the significance 2ⁿ⁻¹, the bits in column S2 have the significance 2ⁿ, and the bits in column S3 have the significance 2ⁿ⁺¹.

The adder (a portion thereof) is represented by the three 4and2-to-3 CR adders B1, B2 and B3. The inputs I0 to I3 of the 4and2-to-3 adder B1 receive the bits of the column S1. Analogously, the inputs I0 to I3 of the 4and2-to-3 CR adders B2 and B3 are supplied by the bits in the columns S2 and S3.

The sum bit outputs S of the 4and2-to-3 CR adders B1, B2, B3 are the n−1-th, n-th and n+1-th place of the binary sum Su of the numbers Z1 to Z4.

In order to ensure correct handling of the carry between the 4and2-to-3 CR adders B1, B2 and B3, the adders are wired as follows: the carry output C0 with a lower significance of the 4and2-to-3 CR adder B1 is connected to a carry input (in FIG. 10 the carry input CI0) of the 4and2-to-3 CR adder B2. The carry output C1 with a relatively high significance of the 4and2-to-3 CR adder B1 is connected to a carry input (in FIG. 10 the carry input CI1) of the 4and2-to-3 CR adder B3. In a corresponding way, the carry output C0 with a relatively low significance of the 4and2-to-3 CR adder B2 is connected to the carry input CI0 of the 4and2-to-3 CR adder B3, and the carry output C1 with a relatively high significance of the 4and2-to-3 CR adder B2 is supplied to a subsequent non-illustrated 4and2-to-3 CR adder which is provided for summing bits with the significance 2ⁿ⁺². In accordance with this scheme, the carry input CI1 of the 4and2-to-3 CR adder B2 is connected to the carry output C1 with a relatively high significance of a preceding non-illustrated 4and2-to-3 CR adder which sums the bits with the significance 2ⁿ⁻².

FIG. 10 shows that the carry-accelerated adder for a maximum of 4-dual numbers can be made up from a single row of 4and2-to-3 CR adders. Analogously, a carry-accelerated adder for a maximum of three dual numbers can be made up from a single row of 3and2-to-3 CR adders.

The adder shown in FIG. 10 for four dual numbers can be used as an output stage of an adder that adds more than four dual numbers (i.e. in other words a multiplicity of bit sets with different significances which each contain more than four bits). In this case, first each bit set must be compressed to four bits by suitable adder trees which are disposed in parallel and connected to one another, as shown in FIG. 1. The four bits per bit set are subsequently added in the “single-line” adder shown in FIG. 10.

In this way, there is a saving in CS adder stages in comparison to a conventional WT adder. The representation of the state of stages in FIG. 2 shows that when an output stage that is composed of 4and2-to-3 CR adders is used (FIG. 10), the stages 8 and 9 can be omitted, and when an output stage composed of 3and2-to-3 CR adders is used the stage 9 can be omitted.

We claim:

1. A 4and2-to-3 bit carry-ripple adder, comprising:
four first inputs for receiving four input bits to be summed and each having a significance w;
two second inputs for receiving two previous carry bits each having the significance w;
a first output for a sum bit with the significance w, said first output coupled to said second inputs; and
two second outputs for two carry bits with significances 2w and 4w, respectively, said second outputs coupled to said first inputs and to said second inputs.

2. The carry-ripple adder according to claim 1, further comprising a maximum number of four gates connected between any of said first inputs and any of said second outputs for the carry bits.

3. The carry-ripple adder according to claim 1, further comprising a maximum number of two gates connected between any of said second inputs and any of said second outputs for the carry bits.

4. The carry-ripple adder according to claim 1, further comprising a maximum number of two gates connected between any of said second inputs and said first output for the sum bit.

5. A 3and2-to-3 bit carry-ripple adder, comprising:
three first inputs for receiving three input bits to be summed and each having a significance w;
two second inputs for receiving two previous carry bits with the significance w;
a first output for a sum bit with the significance w, said first output coupled to said second inputs; and
two second outputs for two carry bits with significances 2w and 4w, respectively, said second outputs coupled to aid first inputs and to said second inputs.

6. The carry-ripple adder according to claim 5, further comprising a maximum number of four gates connected between any of said first inputs and any of said second outputs for the carry bits.

7. The carry-ripple adder according to claim 5, further comprising a maximum number of two gates connected between any of said second inputs and any of said second outputs for the carry bits.

8. The carry-ripple adder according to claim 5, further comprising a maximum number of two gates connected between any of said second inputs and said first output for the sum bit.

9. A carry-accelerated adder for summing a multiplicity of bit sets, the bit sets each having bits with equivalent significances, and the bits from different one of the bit sets having different significances, comprising:
an output end;
bit set adders, and each of the bit sets being assigned one of said bit set adders, each of said bit set adders, while taking into account carries acquired while summing the bit sets with a low significance, calculates a bit with a significance of a respective bit set, at least one of said bit set adders contains a 4and2-to-3 bit carry-ripple adder disposed at said output end, said 4and2-to-3 bit carry-ripple adder including:
four first inputs for receiving four input bits to be summed and each having a significance w;
two second inputs for receiving two previous carry bits each having the significance w;
a first output for a sum bit with the significance w, said first output coupled to said second inputs; and
two second outputs for two carry bits with significances 2w and 4w, respectively, said second outputs coupled to said first inputs and to said second inputs.

10. The carry-accelerated adder according to claim 9, wherein all of the bit sets contain a maximum of 4 bits, and all of said bit set adders are each implemented in a single stage in a form of said 4and2-to-3 bit carry-ripple adder.

11. A carry-accelerated adder for summing a multiplicity of bit sets, the bit sets each having bits with equivalent significances, and the bits from different ones of the bit sets having different significances, comprising:
an output end; and
bit set adders, and each of the bit sets being assigned one of said bit set adders, each of said bit set adders, while taking into account carries acquired while summing the bit sets with a low significance, calculates a bit with a significance of a respective bit set, at least one of said bit set adders contains a 3and2-to-3 bit carry-ripple adder disposed at said output end, said 3and2-to-3 carry-ripple adder including:
three first inputs for receiving three input bits to be summed and each having a significance w;
two second inputs for receiving two previous carry bits with the significance w;
a first output for a sum bit with the significance w, said first output coupled to said second inputs; and
two second outputs for two carry bits with significances 2w and 4w, respectively, said second outputs coupled to said first inputs and to said second inputs.

12. The carry-accelerated adder according to claim 11, wherein all of the bit sets contain a maximum of 3 bits, and all of said the bit set adders are each implemented in one stage in a form of said 3and2-to-3 bit carry-ripple adder.
